(19) United States
(12) Patent Application Publication
(10) Pub. No.: US 2015/0029647 A1
(43) Pub. Date: Jan. 29, 2015

(54) ELECTRONIC DEVICE

(71) Applicant: Hon Hai Precision Industry Co., Ltd., New Taipei (TW)

(72) Inventors: KUANG-SUNG WANG, New Taipei (TW); CHIA-AO CHU, New Taipei (TW)

(73) Assignee: HON HAI PRECISION INDUSTRY CO., LTD., New Taipei (TW)

(21) Appl. No.: 13/950,260

(22) Filed: Jul. 24, 2013

(51) Int. Cl. G06F 1/16

(52) U.S. Cl. CPC G06F 1/1654
USPC 361/679.3

(57) ABSTRACT

An electronic device includes a frame and a display screen. The frame includes a receiving chamber. The receiving chamber has a slot and a first data connecting portion. The display screen is received in the receiving chamber and removable from the receiving chamber. The display screen includes a display surface, a rear surface and a side surface. The display screen further includes an engaging portion and a second data connecting portion. The engaging portion is engaged with the slot of the receiving chamber. The second data connecting portion is configured to exchange data with the first data connecting portion.

### BACKGROUND

1. Technical Field

The present disclosure relates to an electronic device, and especially relates to an electronic device with removable display screen.

2. Description of Related Art

Nowadays, many electronic devices have display screens to illustrate information, such as smart phones and panel computers. In development, display screens used in the electronic devices has a high resolution. However, the display screens with a high resolution will consume more power and reduce battery endurance of the electronic device.

What is needed, therefore, is an electronic device which can overcome the above-described problems.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an assembled, isometric view of an electronic device in accordance with a first embodiment of the disclosure.

FIG. 2 is an exploded view of the electronic device in FIG. 1.

FIG. 3 is an exploded view of the electronic device in FIG. 1, viewed in another aspect.

FIG. 4 is a bottom view of the electronic device in FIG. 1.

FIG. 5 is an illustrating view for assembling a display screen to a frame in FIG. 1.

FIG. 6 is an assembled, isometric view of an electronic device in accordance with a second embodiment of the disclosure.

### DETAILED DESCRIPTION

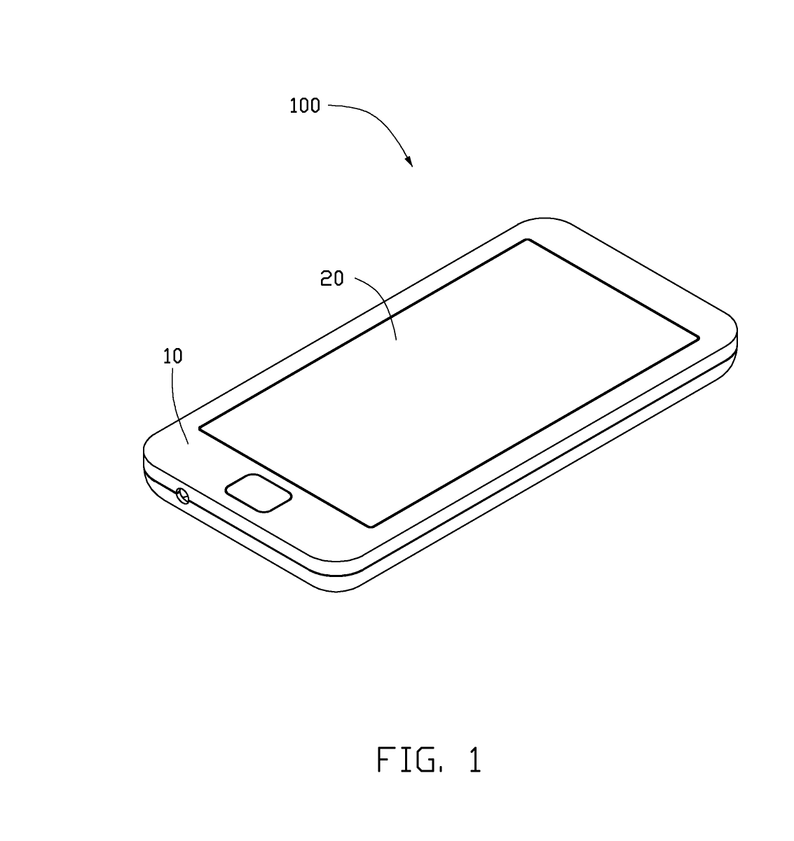

Referring to FIG. 1, an electronic device 100 in accordance with a first embodiment of the disclosure is provided. The electronic device 100 is a smart phone, which includes a frame 10 and a display screen 20 assembled to the frame 10. The display screen 20 is removable from the frame 10.

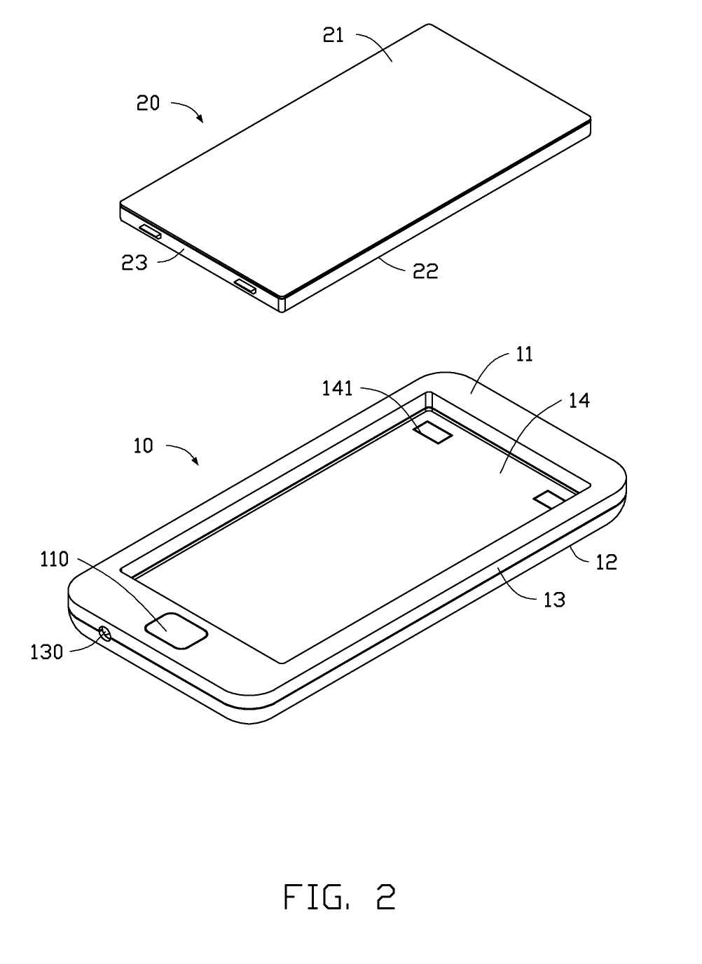

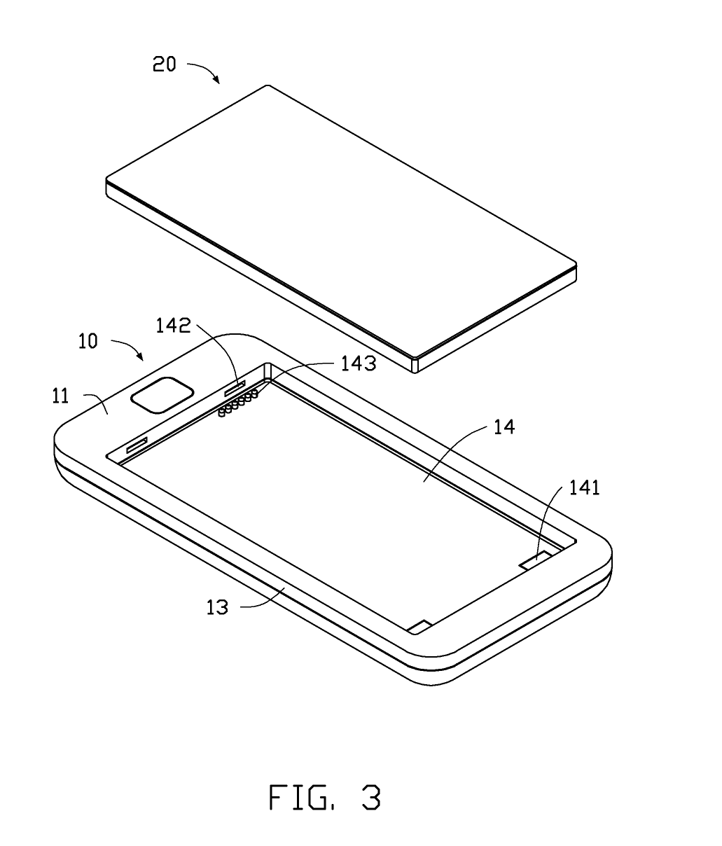

Referring also to FIGS. 2-3, the frame 10 has an upper surface 11, a bottom surface 12, and a lateral surface 13 connected between the upper surface 11 and the bottom surface 12. A receiving chamber 14 is concaved from the upper surface 11 to the bottom surface. The frame 10 further includes a button 110. The button 110 is located at the upper surface 11 of the frame 10 and adjacent to the receiving chamber 14. The button 110 acts as a function key or a power button. A connecting hole 130 is defined at the lateral surface 13 of the frame 10. The connecting hole 130 acts as a power socket of the smart phone to charge a battery of the electronic device 100. In an alternative embodiment, the connecting hole 130 can act as a data jack to exchange data with other electronic devices.

The size and shape of the receiving chamber 14 is corresponding to that of the display screen 20, thereby making the display screen 20 being firmly received in the receiving chamber 14. The receiving chamber 14 is located at a middle portion of the frame 10 and does not extend out of edges of the upper surface 11. In alternative embodiments, the receiving chamber 14 can also extend out of the edges of the upper surface 10. The receiving chamber 14 includes a first assembling portion 141, a slot 142 and a first data connecting portion 143. The first assembling portion 141 and the slot 142 are configured to mechanically connect with the display screen 20. The first data connecting portion 143 are configured to electrically connect and exchange data with the display screen 20. In this embodiment, the receiving chamber 14 includes two first assembling portions 141 and two slots 142. The first assembling portions 141 are located at one end of the receiving chamber 14 away from the button 110. The two slots 142 are located at the other end of the receiving chamber 14 adjacent to the button 110. The two slots 142 are concaved towards the button 110. The first data connecting portion 143 is located at the end of the receiving chamber 14 adjacent to the button 110.

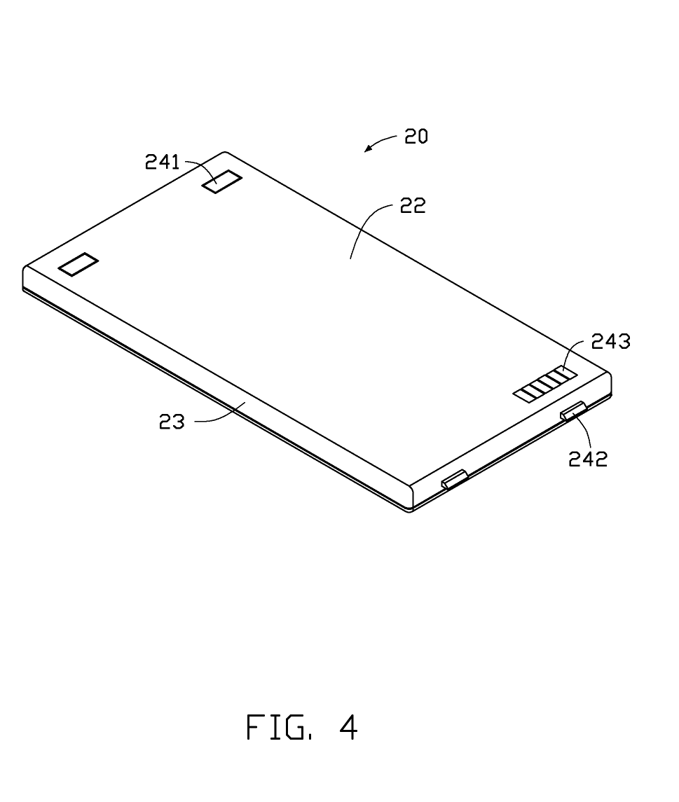

The display screen 20 is an LCD (liquid crystal display) panel. The display screen 20 includes a display surface 21, a rear surface 22 and a side surface 23. The display surface 21 is configured to display information. Preferably, only part of the display surface 21 is used to display information. Edges of the display surface 21 are configured for connecting with the frame 10 and do not display information. When the receiving chamber 14 extends out of the edges of the upper surface 11, the corresponding edge of the display surface 21 will not display information. Furthermore, the display surface 21 can act as a touch panel. Preferably, when the display screen 20 is received in the receiving chamber 14, the display surface 21 is coplanar with the upper surface 11 of the frame 10. Referring also to FIG. 4, the rear surface 22 of the display screen 20 has a second assembling portion 241 and a second data connecting portion 243. The second assembling portion 241 is mechanically connected with the first assembling portion 141 of the frame 10. The second data connecting portion 243 is electrically connected and exchanges data with the first data connecting portion 143. In this embodiment, the second assembling portion 241 is mechanically connected with the first assembling portion 141 by magnetic force. In addition, the display screen 20 further comprises an engaging portion 242 to engage with the slot 142 of the frame 10. The engaging portion 242 is located at the side surface 23 of the display screen 20 and the end of the engaging portion 242 obliquely extends out of the side surface 23.

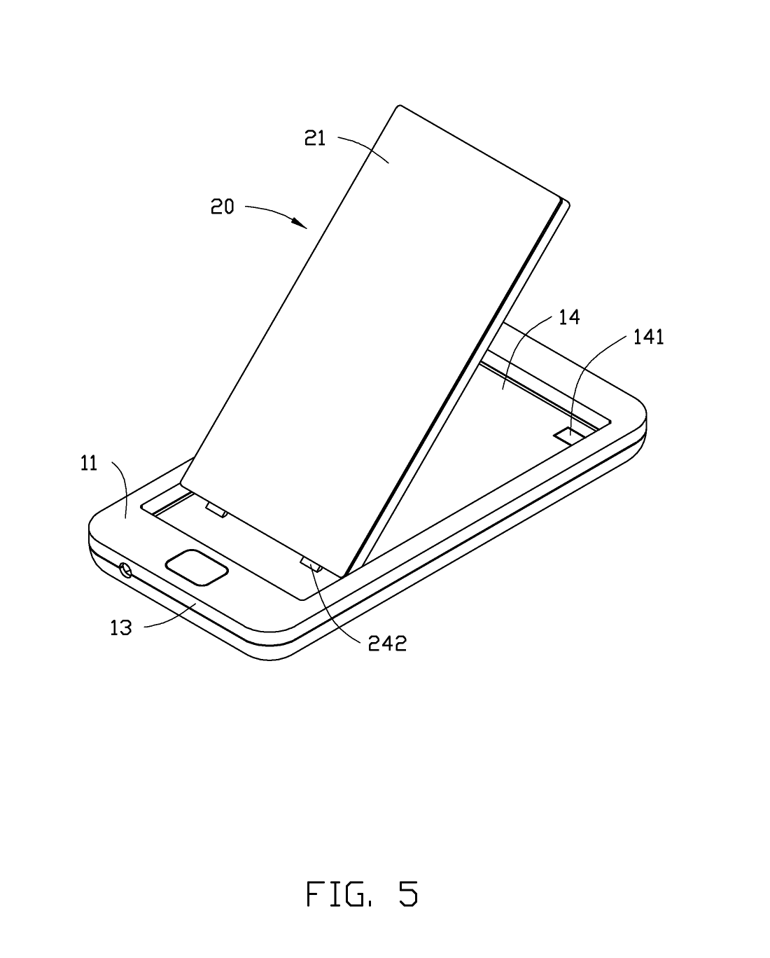

As referring to FIG. 5, when the display screen 20 is assembled to the frame 10, the rear surface 22 of the display screen 20 is in a position adjacent to the receiving chamber 14, and the display surface 21 is in a position away from the receiving chamber 14. The display screen 20 forms an included angle of 45 degrees with the receiving chamber 14 to insert the engaging portion 242 into the slot 142 of the frame 10. In assembling, the included angle between the display screen 20 and the receiving chamber 14 gradually decreases until the engaging portion 242 is totally inserted into the slot 142 of the frame 10. At that time, the first assembling portion 141 will be connected with the second assembling portion 241 by magnetic force. That is, through the connections between the first assembling portion 141 and the second assembling portion 241, and connection between the engaging portion 242 and the slot 142, the display screen 20 is received in the receiving chamber 14 of the frame 10. Since the end of the engaging portion 242 obliquely extending out of the side surface 23 of the display screen 20, the engaging portion 242 can be easily inserted into slot 142. Since the first assembling portion 141 is connected with the second assembling portion 241 by magnetic force, when providing a force to counterweigh the magnetic force, the display screen 20 can be removed from the receiving chamber 14 of the frame 10.

Since the display screen 20 is removable from the frame 10, the display screen 20 can be replaced by another different display screen 20. At that time, the electronic device 100 can includes two or more display screens 20. For example, one display screen 20 has a resolution of 540*960, and the other display screen 20 has a resolution of 320*640. When users need a high resolution, the display screen with the resolution of 540*960 is assembled to the receiving chamber 14 of the frame 10. When the users need a relatively low resolution to reduce power consumption, a display screen with the resolution of 320*640 is assembled to the receiving chamber 14 of the frame 10.

Before the display screen 20 is assembled to the frame 10, the frame 10 is in a standby node. When the display screen 20 is assembled to the frame 10, the frame 10 will determine the kind of the display screen 20 and start corresponding software to drive the display screen 20.

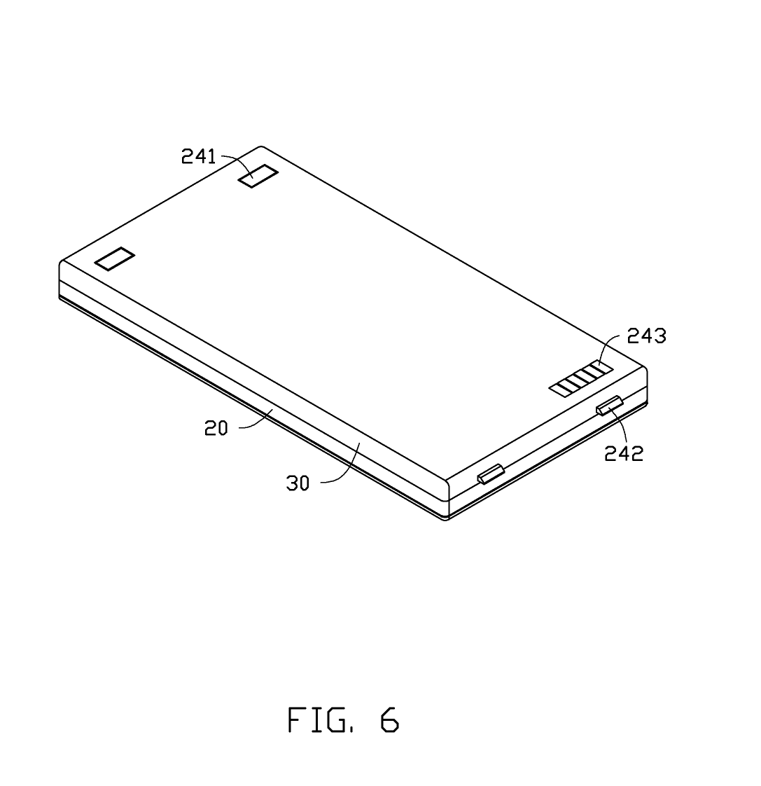

As referring to FIG. 6, the display screen 20 further includes battery module 30 for providing power for the electronic device 10. The battery module 30 is configured to increase the battery endurance of the electronic device 100. In this embodiment, the battery module 30 is formed at the rear surface 22 of the display screen 20 and covers the rear surface 22. In alternative embodiments, the battery module 30 can also be formed on the side surface 23 of the display screen 20.

It is to be understood, however, that even though numerous characteristics and advantages of various embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An electronic device, comprising:
a frame having a receiving chamber, the receiving chamber comprising a slot and a first data connecting portion; and
a display screen received in the receiving chamber, the display screen being removable from the receiving chamber, the display screen comprising a display surface, a rear surface and a side surface, an engaging portion is formed on the display screen to engage with the slot of the receiving chamber, and a second data connecting portion is formed at the display screen to exchange data with the first data connecting portion.

2. The electronic device of claim 1, wherein the engaging portion is formed at the side surface of the display screen, and one end of the engaging portion obliquely extends out of the side surface.

3. The electronic device of claim 1, wherein the receiving chamber further comprises a first assembling portion, and the rear surface of display screen has a second assembling portion to mechanically connect with the first assembling portion.

4. The electronic device of claim 3, wherein the second assembling portion is mechanically connected with the first assembling portion by magnetic force.

5. The electronic device of claim 1, wherein the frame comprises an upper surface, a bottom surface, and a lateral surface connected between the upper surface and the bottom surface, and the receiving chamber is concaved from the upper surface to the bottom surface.

6. The electronic device of claim 5, wherein the frame further comprises a button located at the upper surface adjacent to the receiving chamber, and the button acts as a function key or a power button.

7. The electronic device of claim 6, wherein the slot is located at one end of the receiving chamber adjacent to the button and concave towards the button, and the first data connecting portion is also located at the end of the receiving chamber adjacent to the button.

8. The electronic device of claim 5, wherein frame further comprises a connecting hole located at the lateral surface of the frame, and the connecting hole acts as a power socket to charge a battery of the electronic device or a data jack to exchange data with other electronic devices.

9. The electronic device of claim 1, wherein before the display screen is assembled to the frame, the frame is in standby node, and when the display screen is assembled to the frame, the frame determines a kind of the display screen and start corresponding software to drive the display screen.

10. The electronic device of claim 1, wherein the display screen further comprises a battery module to provides power for the electronic device.

11. An electronic device, comprising:
a frame having a receiving chamber, the receiving chamber comprising a slot and a first data connecting portion; and
two different display screens, one of the display screen received in the receiving chamber and being removable from the receiving chamber, each of the display screen comprising a display surface, a rear surface and a side surface, each of the display screen having an engaging portion engaged with the slot of the receiving chamber, and a second data connecting portion to exchange data with the first data connecting portion, the two display screens having different resolutions.

12. The electronic device of claim 11, wherein the engaging portion is formed at the side surface of each of the display screens, and one end of the engaging portion obliquely extends out of the side surface.

13. The electronic device of claim 11, wherein the receiving space further comprises a first assembling portion, and the rear surface of each of the display screens has a second assembling portion to mechanically connect with the first assembling portion.

14. The electronic device of claim 13, wherein the second assembling portion is mechanically connected with the first assembling portion by magnetic force.

15. The electronic device of claim 11, wherein the frame comprises an upper surface, a bottom surface, and a lateral surface connected between the upper surface and the bottom surface, and the receiving chamber is concaved from the upper surface to the bottom surface.

16. The electronic device of claim 15, wherein the frame further comprises a button located at the upper surface adjacent to the receiving chamber, and the button acts as a function key or a power button.

17. The electronic device of claim 16, wherein the slot is located at one end of the receiving chamber adjacent to the button and concave towards the button, and the first data connecting portion is also located at the end of the receiving chamber adjacent to the button.

18. The electronic device of claim 15, wherein frame further comprises a connecting hole located at the lateral surface of the frame, and the connecting hole acts as a power socket to charge a battery of the electronic device or a data jack to exchange data with other electronic devices.

19. The electronic device of claim 11, wherein before the display screens are assembled to the frame, the frame is in standby node, and when one of the display screens is assembled to the frame, the frame determines a kind of the display screen and start corresponding software to drive the display screen.

20. The electronic device of claim 11, wherein the display screen further comprises a battery module to provides power for the electronic device.
